(19) United States
(12) Patent Application Publication
(10) Pub. No.: US 2025/0391619 A1
(43) Pub. Date: Dec. 25, 2025

(54) CIRCUIT BREAKER AND METHOD

(71) Applicant: Siemens Aktiengesellschaft, München (DE)

(72) Inventor: Marvin Tannhäuser, Hausen (DE)

(21) Appl. No.: 19/107,734

(22) PCT Filed: Aug. 23, 2023
(86) PCT No.: PCT/EP2023/073141

§ 371 Date: Feb. 28, 2025

(30) Foreign Application Priority Data
Aug. 31, 2022 (DE) 10 2022 209 033.0

(51) Int. Cl. H01H 9/54; H01H 71/12; H02H 3/093; H02H 3/347

(52) U.S. Cl. CPC H01H 9/547; H01H 71/125; H02H 3/0935; H02H 3/347; H01H 2071/124

(57) ABSTRACT

A circuit breaker for protecting a low-voltage electric circuit for an AC voltage, ascertains the level of an instantaneous differential current of conductors of the low-voltage circuit. If an instantaneous differential current quantity has been overshot, a prevention of current flux in the low-voltage circuit is initiated by a high-ohmic state of switching elements of an electronic interruption unit in the closed state of break contacts. A method for using a circuit-breaker for protecting a low-voltage electric circuit for an AC voltage, is also provided.

The invention relates to the technical field of a circuit-breaker for a low-voltage circuit having an electronic interruption unit, according to the introductory clause of patent claim 1, and to a method for a circuit-breaker for a low-voltage circuit having an electronic interruption unit.

The term “low voltage” signifies voltages of up to 1, 000 volts AC or up to 1, 500 volts DC. In particular, the term “low voltage” signifies voltages which are greater than the extra-low voltage, having values of 50 volts AC or 120 volts DC.

The terms “low-voltage circuit” or “low-voltage network” or “low-voltage installation” signify circuits having nominal currents or rated currents of up to 125 amperes, specifically of up to 63 amperes. In particular, the term “low-voltage circuit” signifies circuits having nominal currents or rated currents of up to 50 amperes, 40 amperes, 32 amperes, 25 amperes, 16 amperes or 10 amperes. In particular, the above-mentioned current values signify nominal, rated or cut-off currents, i.e. the maximum current which, under normal circumstances, is conducted via the circuit, or with effect from which the electric circuit is customarily interrupted, for example by means of a protective device, such as a circuit-breaker, a line circuit-breaker or a power circuit-breaker. Nominal currents can be further staggered, from 0.5 A through 1 A, 2 A, 3 A, 4 A, 5 A, 6 A, 7 A, 8 A, 9 A, 10 A, etc., up to 16 A.

Line circuit-breakers are well-known overcurrent protection devices, which are employed in electrical installation engineering in low-voltage circuits. Line circuit-breakers protect lines against damage resulting from a heat-up associated with an excessively high current and/or a short-circuit. A line circuit-breaker can automatically interrupt the circuit in the event of an overload and/or a short-circuit. A line circuit-breaker is a protective element with no automatic reset.

Power circuit-breakers, conversely to line circuit-breakers, are designed for currents in excess of 125 A and, in some cases even for currents of 63 A or higher. Consequently, line circuit-breakers assume a simpler and more delicate design. Line circuit-breakers customarily comprise a fastening facility for fastening to a “top hat rail” (mounting rail, DIN rail, or TH35).

Line circuit-breakers according to the prior art are of an electromechanical design. In a housing, they comprise a mechanical switching contact or open-circuit shunt release for the interruption (tripping) of electric current. Customarily, a bimetallic protective element or bimetallic element is employed for tripping (interruption) in the event of a prolonged overcurrent (overcurrent protection) or in the event of a thermal overload (overload protection). An electromagnetic trip element having a coil is employed for short-term tripping in the event of an overshoot of an overcurrent limiting value, or in the event of a short-circuit (short-circuit protection). One or more arc-quenching chamber(s) or arc-quenching devices are provided. Connecting elements for conductors of the electric circuit which is to be protected are also provided.

Fault current circuit-breakers for electric circuits, in particular for low-voltage circuits or installations, are generally known. Fault current circuit-breakers are also described as residual-current devices, or RCDs for short. Fault current circuit-breakers ascertain the summated current in an electric circuit which, under normal circumstances, is equal to zero, and interrupt the electric circuit in the event of an overshoot of a differential current value, i.e. a summated current which is not equal to zero, and which exceeds a specific (differential) current value or fault current value.

Almost all existing fault current circuit-breakers comprise a summation current transformer, the primary winding of which is formed by the conductors of the circuit, and the secondary winding of which outputs the summated current which, directly or indirectly, is employed for interrupting the electric circuit.

To this end, two or more conductors, generally the supply and return conductors or the phase and neutral conductors in a single-phase AC network, all three phase conductors, or all three phase conductors and the neutral conductor in a three-phase AC network, are led through a transformer generally having an annular core of a ferromagnetic material. Only the differential current on the conductors, i.e. a current which deviates from the supply and return current, is transformed. Customarily, the summated current in an electric circuit is equal to zero. Fault currents can be detected accordingly.

A flow of current to ground, for example, on the energy sink side or load side, is described in this context as a fault current. A fault is present, for example, in the event that an electrical connection exists between a phase conductor of the electric circuit and ground. This occurs, for example, if a person touches the phase conductor. In this case, a proportion of electric current does not flow back, as is customary, via the neutral conductor or PEN conductor, but flows through the person and ground. This fault current can be detected by means of the summation current transformer, as the quantitative sum of the inflow and the return flow of current thus captured is not equal to zero. By means of a relay or a retention magnet trip element, for example having an associated mechanism, an interruption of the circuit, e.g. of at least one, of a proportion, or of all conductors is executed. Fault current circuit-breakers for the detection of AC fault currents are generally known from printed publication DE 44 32 643 A1. The primary function of fault current circuit-breakers is the protection of persons against electric currents (electric shock), and the protection of installations, machines or buildings against fire caused by electrical insulation faults.

If the fault current circuit-breaker, or the summation current transformer thereof, is configured such that the secondary side energy of the summation current transformer is sufficient for actuating a trip unit, an interruption unit or a trip element, a fault current circuit-breaker of this type is described as system voltage-independent.

If auxiliary energy is required or employed for the trip circuit, which auxiliary energy, in general, is generated by a power supply unit which is provided in the fault current circuit-breaker, a fault current circuit-breaker of this type is described as a system voltage-dependent fault current circuit-breaker. This means that system voltage-dependent fault current circuit-breakers contain a power supply unit for the supply of energy for a fault current detection function (and are thus not system voltage-independent). These power supply units are necessary, for example, for the detection of fault currents in DC voltage networks and in combined DC/AC networks, or in high-frequency circuits.

Circuit-breakers having an electronic interruption unit represent a relatively novel development. These circuit-breakers comprise a semiconductor-based electronic interruption unit. This means that the electric current flux of the low-voltage circuit is routed via semiconductor components or semiconductor switches, which can be switched for the interruption of the electric current flux, or for the conduction thereof. In many cases, circuit-breakers having an electronic interruption unit further comprise a mechanical break contact system, in particular having breaking properties in accordance with applicable standards for low-voltage circuits, wherein the contacts of the mechanical break contact system are connected in series with the electronic interruption unit, i.e. the current of the low-voltage circuit which is to be protected is routed both via the mechanical contact system and via the electronic interruption unit.

In particular, the present invention relates to low-voltage AC circuits having an AC voltage, customarily having a time-dependent sinusoidal AC voltage at a frequency f. The temporal dependence of the instantaneous voltage value u(t) of the AC voltage is described by the equation:

$$u ( t ) = U * sin ( 2 π * f * t )$$

wherein:
u(t)=the instantaneous voltage value at time t
U=the voltage amplitude

A harmonic AC voltage can be represented by the rotation of a pointer, the length of which corresponds to the voltage amplitude (U). Instantaneous deflection is represented by the projection of the pointer on a coordinate system. An oscillation period corresponds to one full rotation of the pointer, and the full angle thereof is 2π (2pi) or 360°. The angular frequency is the rate of variation of the phase angle of this rotating pointer. The angular frequency of a harmonic oscillation is always 2π-times the frequency thereof, such that:

$$ω = 2 π * f = 2 π / T = angular frequency of alternating voltage$$

$$( T = period of oscillation )$$

In many cases, an indication of angular frequency (ω) is preferred over frequency (f), on the grounds that numerous formulae in oscillation theory, as a result of the involvement of trigonometric functions, the period of which, by definition, is 2π, can be represented in a more compact manner using the angular frequency:

$$u ( t ) = U * sin ( ω t )$$

In the case of temporally non-constant angular frequencies, the term “instantaneous angular frequency” is also employed.

In a sinusoidal, particularly a temporally constant, AC voltage, the time-dependent value given by the angular velocity ω and the time t corresponds to the time-dependent angle φ(t), which is also described as the phase angle φ(t). This means that the phase angle φ(t) periodically describes the range of 0 . . . 2π or 0° . . . 360°. This means that the phase angle periodically assumes a value between 0 and 2π, or between 0° and 360° (φ=n*(0 . . . 2π) or φ=n*(0° . . . 360°), as a result of periodicity; in short: φ=0 . . . 2π or φ=0° . . . 360°.

In consequence, the instantaneous voltage value u(t), or the instantaneous current value, or the instantaneous differential current value signifies the instantaneous value of the voltage/current/differential current at a time point t, i.e. in a sinusoidal (periodic) AC voltage, the value of the voltage/current/differential current at the phase angle φ (φ=0 . . . 2π or φ=0° . . . 360°, for the respective period).

The object of the present invention is the improvement of a circuit-breaker of the above-mentioned type, particularly in the interests of ensuring the protection of persons against fault currents while simultaneously maintaining security of supply or the availability of electrical installations, i.e. the achievement of immunity against technically related (fault) currents which would result in the spurious tripping of the circuit-breaker. In other words, firstly, the protection of persons is ensured and, secondly, security of supply on a low-voltage circuit is improved. Alternatively, a novel concept for a circuit-breaker of this type is provided.

This object is fulfilled by a circuit-breaker having the features of patent claim 1, and by a method as claimed in patent claim 10.

According to the invention, a circuit-breaker for protecting a low-voltage electric circuit, in particular a low-voltage AC circuit is provided, comprising the following:
a housing, having grid-side and load-side terminals for conductors of the low-voltage circuit;
a differential current sensor unit for ascertaining the magnitude of a differential current in the conductors of the low-voltage circuit, in particular for capturing the temporal characteristic of the instantaneous differential current value;
a mechanical break contact unit, which assumes a closed state of contacts for enabling a current flux in the low-voltage circuit, or an open state of contacts for preventing a current flux by the galvanic interruption of the low-voltage circuit;
   the mechanical break contact unit, in particular, is operable and switchable by means of a mechanical handle, such that an opening of contacts for preventing a current flux or a closing of contacts for enabling a current flux in the low-voltage circuit is selectable (by means of the handle), and thus (in particular) a galvanic interruption of the low-voltage circuit is selectable;
   in a mechanical break contact unit, an opening of contacts is also described as an isolation, and a closing of contacts is also described as a connection;
an electronic interruption unit which, on the circuit side, is connected in series with the mechanical break contact unit and which, by means of semiconductor-based switching elements, assumes a high-ohmic (in particular, a non-conducting) state of switching elements for preventing a current flux, or a low-ohmic state of switching elements for enabling a current flux in the low-voltage circuit;
   in an electronic interruption unit, a high-ohmic (in particular, a non-conducting) state of switching elements (for preventing a current flux) is also described as a switched-off state (function: switch-off), and a low-ohmic (conducting) state of switching elements (for enabling a current flux) is also described as a switched-on state (function: switch-on);
a control unit, which is connected to the differential current sensor unit, to the mechanical break contact unit and to the electronic interruption unit.

According to the invention, the circuit-breaker, in particular the control unit, is configured such that the magnitude of the instantaneous differential current is compared with an instantaneous differential current limiting value, and in the event of, in particular, a quantitative overshoot, a prevention of a current flux in the low-voltage circuit is initiated by a high-ohmic state of the switching elements of the electronic interruption unit, with the break contacts in a closed state.

This has a particular advantage, in that a novel prevention of a current flux in the low-voltage circuit is provided by the employment of the instantaneous differential current value, such that an instantaneous switch-off in the event of a quantitative overshoot “instantaneously” initiates a high-ohmic state of the switching elements of the electronic interruption unit, with the break contacts in a closed state.

Advantageously, in the event of an overshoot of the instantaneous differential current limiting value, prevention of the current flux in the low-voltage circuit is executed by means of a high-ohmic state of the switching elements of the electronic interruption unit within a first break time. The first break time, in particular, is less than 20 ms, specifically less than 15 ms, 10 ms, 5 ms, 1 ms, 500 μs or 100 μs.

Further advantageous configurations of the invention are disclosed in the sub-claims and in the exemplary embodiment.

Advantageously, further to the prevention of the current flux in the low-voltage circuit, initiated in response to the overshoot of the instantaneous differential current value, a low-ohmic state is assumed by the switching elements of the electronic interruption unit.

This provides a particular advantage, in that an automatic reclosing is executed, and a high availability of the energy supply is achieved accordingly.

In particular, assumption of a low-ohmic state is executed where a magnitude of the instantaneous value of the AC voltage (which is applied to the circuit-breaker) is lower than a first voltage limit. The first voltage limit, in particular, is lower than 20 volts or 10 volts, or lower than 5 volts. Specifically, a low-ohmic state of switching elements of the electronic interruption unit can be assumed in a zero-crossing of the AC voltage.

This means that the circuit-breaker is switched to the standby state and, e.g. at the next voltage zero-crossing, is automatically restored to the on-state.

To this end, advantageously, a voltage sensor unit, which is connected to the control unit, is provided for ascertaining the magnitude of a voltage in the conductors of the low-voltage circuit.

This additionally provides a particular advantage in that, further to a non-conforming differential current event which is caused, for example, by the contact of a person with a (phase) conductor (critical event), or by a technically related leakage current (which is not critical to persons, i.e. a non-critical event) (associated, for example, with the switching of capacitances), an instantaneous prevention of a current flux in the low-voltage circuit is initiated by a high-ohmic state of the switching elements of the electronic interruption unit.

Further to the prevention of the current flux by means of a high-ohmic state of the switching elements of the electronic interruption unit and a closed state of the contacts initiated in response to the instantaneous differential current limiting value, a low-ohmic state is assumed, such that a further check for the presence of non-conforming differential current events can be executed. It is thus possible to distinguish between critical and non-critical events, while providing a maximum security of energy supply in the circuit such that, firstly, the protection of persons and, secondly, the availability of installations are ensured. The state in force on the load-side terminals can thus be further monitored with respect to the presence of differential current limiting values. In the event of a change of state, advantageously, a further action can be executed, for example according to further advantageous configurations of the invention.

An entirely novel operating concept for a (FI) circuit-breaker is thus envisaged.

Advantageously, by means of the mechanical handle, in particular, only the mechanical break contact unit is operable. A switch-on and switch-off by means of the electronic interruption unit cannot be executed (directly) on the device.

In an advantageous configuration of the invention, further to the assumption of the low-ohmic state, a further overshoot of the instantaneous differential current limiting value is detected. A high-ohmic state is assumed, followed by the assumption of a low-ohmic state. In the event of the occurrence of further overshoots of the instantaneous differential current limiting value (with the associated assumption of high-ohmic and low-ohmic states), this sequence is only executed until such time as a first number of overshoots has been achieved. The first number can be 2, or can range from 3 to 20.

The electronic interruption unit then remains in a high-ohmic state. This state can remain in force until a further time limit is exceeded. Alternatively or additionally, this state can be communicated by a communication unit.

Alternatively or additionally, the contacts of the mechanical break contact unit can be opened.

This has a particular advantage, in that a concept for a robust circuit-breaker is provided which ensures a high availability of the energy supply.

In an advantageous configuration of the invention, a r.m.s. value of the differential current is ascertained from the magnitude of the instantaneous differential current. The r.m.s. value of the differential current is compared with a r.m.s. differential current limiting value or with a r.m.s. differential current-time limiting value and, in the event of an overshoot, prevention of a current flux in the low-voltage circuit is initiated:
a) by a high-ohmic state of the switching elements of the electronic interruption unit, with the break contacts in a closed state, or
b) by an open state of the break contacts.

This has a particular advantage, in that two evaluations for the differential current thus captured are provided.

The first of these involves a r.m.s. differential current-time limiting value, which corresponds to a conventional evaluation, of the type which is currently employed in fault current circuit-breakers according to the prior art. However, the outcome of the evaluation involves two potential means for preventing a current flux. The first of these is a conventional prevention of a current flux in the low-voltage circuit by means of an open state of the break contacts, i.e. a galvanic isolation. The second of these is a novel prevention, by means of a high-ohmic state of the switching elements of the electronic interruption unit, with the break contacts in the closed state.

For the evaluation of the r.m.s. differential current-time limiting value, advantageously, the r.m.s. value of the differential current can be employed. This can be executed, for example, by means of a r.m.s. value (root mean square) ascertainment of the differential current. In the event of an overshoot of the corresponding regulation (FI circuit-breaker) current/time limiting values, one of the two above-mentioned means for preventing the current flux is executed. Alternatively, the novel and parallel evaluation of an instantaneous differential current limiting value employs the instantaneous value of the differential current, such that an instantaneous switch-off in the event of a quantitative overshoot “instantaneously” initiates a high-ohmic state of the switching elements of the electronic interruption unit, with the break contacts in a closed state.

In an advantageous configuration of the invention, the circuit-breaker is configured such that the instantaneous differential current limiting value is quantitatively higher than the r.m.s. differential current limiting value or the r.m.s. differential current-time limiting value (differential current component). In particular, the instantaneous differential current limiting value is a value within the range of 2- to 100-times the r.m.s. differential current limiting value or the r.m.s. differential current-time limiting value. This provides a particular advantage, in that the instantaneous switch-off is only executed in the event that an instantaneous differential current value occurs which is consistently greater than the continuously permissible differential current. Additionally, an adjustability of the second differential current limiting value enables the threshold to be adapted to the operating situation in force and to the occurrence of any in-service events or malfunctions which impact upon the differential current.

In an advantageous configuration of the invention, a current sensor unit which is connected to the control unit is provided for ascertaining the magnitude of a current in the conductors of the low-voltage circuit. The circuit-breaker, in particular the control unit, is configured such that, in the event of an overshoot of first current limiting values or of first current-time limiting values, a prevention of a current flux in the low-voltage circuit is initiated by a high-ohmic state of the switching elements of the electronic interruption unit, with the break contacts in a closed state. This has a particular advantage in that, in addition to differential current detection and the associated protective functions, an overcurrent/short-circuit current detection function is also provided such that, advantageously, a combined fault-current/line protection circuit-breaker is provided.

In an advantageous configuration of the invention, the mechanical break contact unit is assigned to the load-side terminals.

This has a particular advantage, in that an architecture which supports the behavior of the circuit-breaker according to the invention is provided, on the grounds that, on the one hand, the current flux is interrupted in the event of a high-ohmic state of the interruption unit whereas, however, the circuit-breaker continues to be supplied with energy, even where the contacts are open, such that a continuing operation according to the invention is enabled.

According to the invention, a corresponding method is claimed for a circuit-breaker for a low-voltage circuit, having electronic (semiconductor-based) switching elements, which method has identical and further advantages.

According to the invention, a corresponding computer program product for a circuit-breaker is claimed. The computer program product comprises commands which, upon the execution of the program by a microcontroller, initiate the execution or support by the latter of configurations or methods of the circuit-breaker according to the invention.

In particular, in the event of an overshoot of an instantaneous differential current limiting value, a prevention of a current flux in the low-voltage circuit is initiated by a high-ohmic state of the switching elements of the electronic interruption unit, with the break contacts in a closed state. The microcontroller is an element of the circuit-breaker, in particular of the control unit.

According to the invention, a corresponding computer-readable storage medium is claimed, on which the computer program product is saved.

According to the invention, a corresponding data carrier signal is claimed, which is transmitted by the computer program product.

All configurations, whether in the dependent form relating to patent claims 1 to 10, or relating only to individual features or combinations of features of the patent claims, in particular with reference to the dependent claims with respect to the assembly and to the independent claim with respect to the method, effect an improvement of a circuit-breaker, in particular an improvement of the safety of persons and of the security of supply in low-voltage circuits, and thus provide a novel and secure concept for a circuit-breaker.

The above-mentioned properties, features and advantages of the present invention, and the manner in which these are achieved, are further explained and clarified in conjunction with the following description of exemplary embodiments, which are described in greater detail with reference to the drawing.

In the drawing:

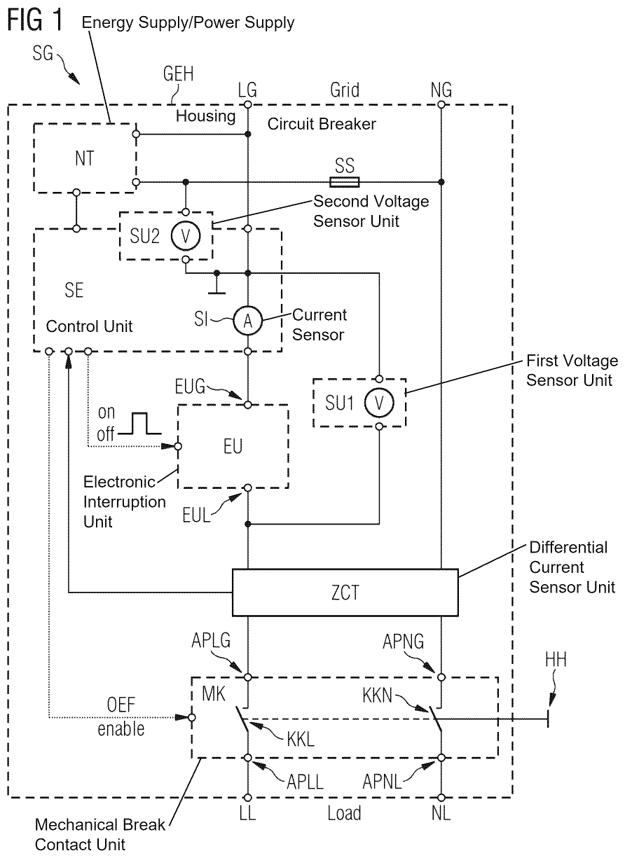

FIG. 1 shows a first schematic representation of a circuit-breaker;

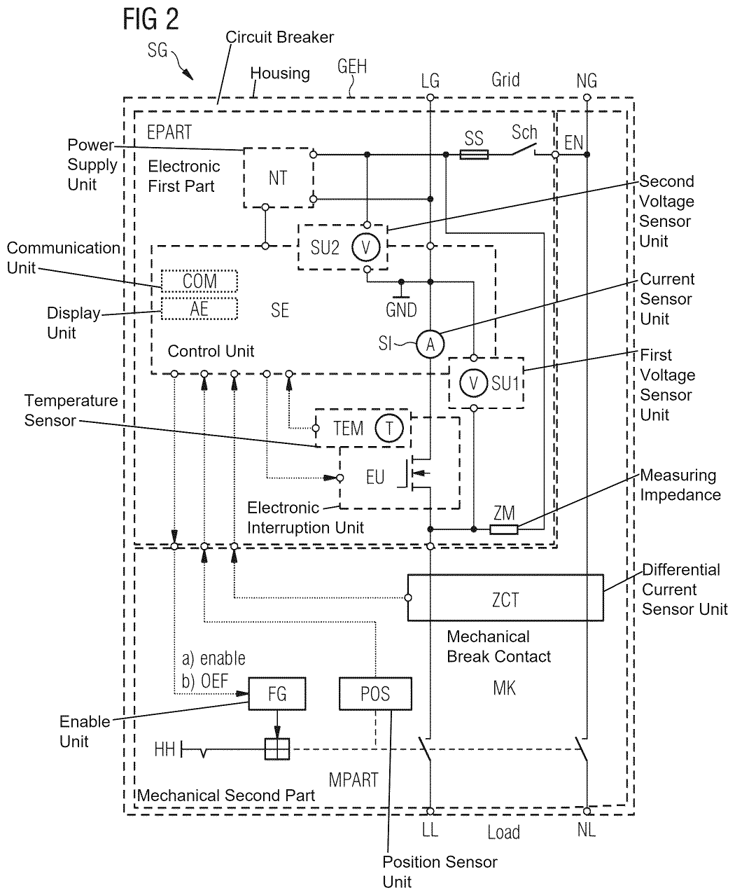

FIG. 2 shows a second schematic representation of a circuit-breaker;

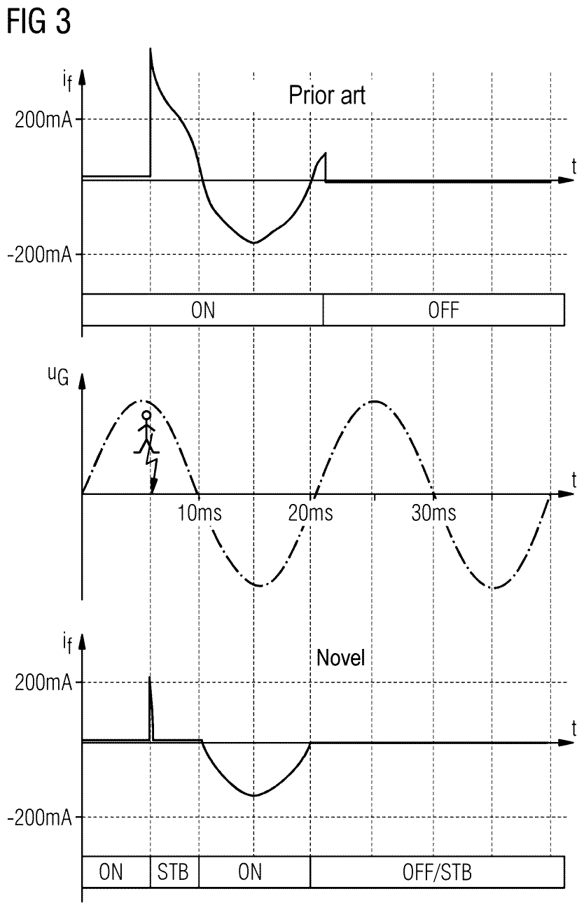

FIG. 3 shows a first representation of a switching behavior;

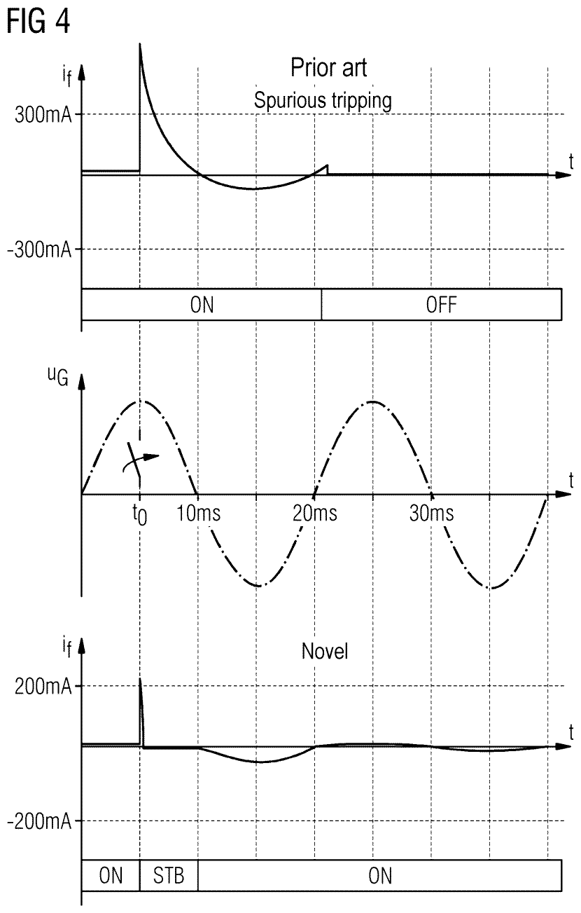

FIG. 4 shows a second representation of a switching behavior;

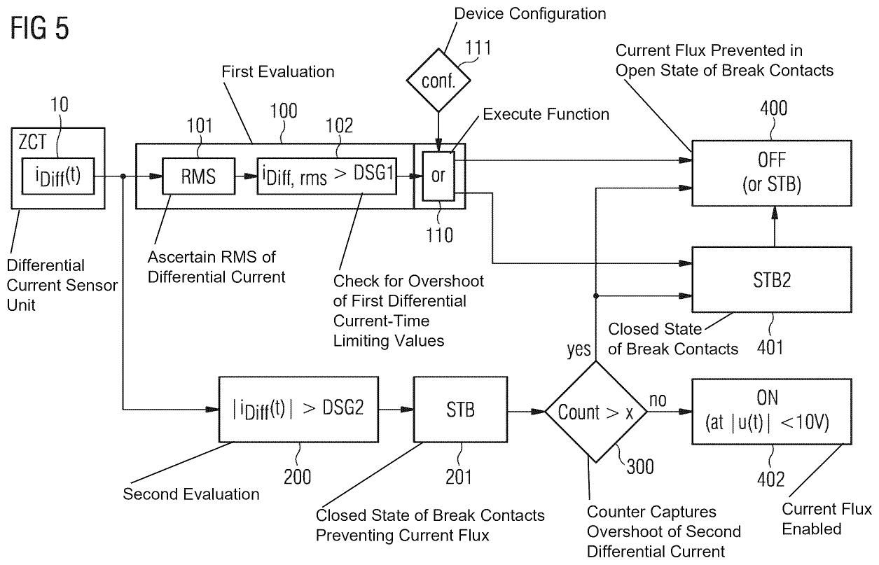

FIG. 5 shows a representation of a functional sequence.

FIG. 1 shows a representation of a circuit-breaker SG for protecting a low-voltage electric circuit, in particular a low-voltage AC circuit, having a housing GEH, and comprising:
grid-side terminals which comprise, in particular, a grid-side neutral conductor terminal NG and a grid-side phase conductor terminal LG;
load-side terminals which comprise, in particular, a load-side neutral conductor terminal NL and a load-side phase conductor terminal LL;
the terminals are provided for the low-voltage circuit;
at the grid-side terminals/grid side (Grid), an energy source is customarily connected;
at the load-side terminals/load side (Load), a load is
a (two-pole) customarily connected; mechanical break contact unit MK, having load-side connection points APLL, APNL, and grid-side connection points APLG, APNG; wherein a load-side connection point APNL is provided for the neutral conductor, a load-side connection point APLL is provided for the phase conductor, a grid-side connection point APNG is provided for the neutral conductor, and a grid-side connection point APLG is provided for the phase conductor. The load-side connection points APNL, APLL are connected to the load-side neutral and phase terminals NL, LL, such that an opening of contacts KKN, KKL is switchable for preventing a current flux, or a closing of contacts KKN, KKL is switchable for enabling a current flux in the low-voltage circuit;
an, in particular, single-pole electronic interruption unit EU (which, in particular, in the case of a single-pole embodiment, is arranged in the phase conductor),
   having a grid-side connection point EUG, which is electrically connected to the grid-side phase conductor terminal LG, and
   having a load-side connection point EUL, which is electrically bonded with, or electrically connected to, the grid-side connection point APLG of the mechanical break contact unit MK, wherein the electronic interruption unit EU, by means of (unrepresented) semiconductor-based switching elements, assumes or is switchable to a high-ohmic state of the switching elements, for preventing a current flux, or to a low-ohmic state of the switching elements, for enabling a current flux in the low-voltage circuit;
a differential current sensor unit ZCT, for ascertaining the magnitude of an (instantaneous) differential current on the conductors of the low-voltage circuit, which differential current sensor unit ZCT, in the example represented, is arranged between the electronic interruption unit EU and the mechanical break contact unit MK and, alternatively, can be provided (arranged) between the mechanical break contact unit MK and the load-side neutral and phase conductor terminals NL, LL and, further alternatively, can be provided (arranged) between the electronic interruption unit EU and the grid-side terminals NG, LG. The differential current sensor unit ZCT ascertains the magnitude of the differential current which is routed through the circuit-breaker to the conductors of the low-voltage circuit (which are to be protected). In the present example, a single-phase AC circuit is comprised of a neutral conductor and a phase conductor.

The differential current sensor unit ZCT can be a conventional summation current transformer. The primary side of the summation current transformer is formed by the conductors of the low-voltage circuit (in the present example, the neutral conductor and phase conductor). The secondary side of the summation current transformer is connected to the control unit SE;
(optionally) a current sensor unit SI for ascertaining the magnitude of the current in the low-voltage circuit and which, in particular, is arranged in the current path of the phase conductor, or the phase conductor current path;
a control unit SE, which is connected to the differential current sensor unit ZCT, (optionally) to the current sensor unit SI, to the mechanical break contact unit MK, and to the electronic interruption unit EU.

According to the invention, the circuit-breaker SG, in particular the control unit SE, is configured such that
the magnitude of the instantaneous differential current is compared with an instantaneous differential current limiting value DSGm and, in the event of an, in particular quantitative, overshoot, a prevention of a current flux in the low-voltage circuit is initiated by a high-ohmic state of the switching elements of the electronic interruption unit, with the break contacts in the closed state.

Thus, in the event of an overshoot of the instantaneous differential current limiting value DSGm, a current flux in the low-voltage circuit is prevented by a high-ohmic state of the switching elements of the electronic interruption unit within a first switch-off time which, in particular, is less than 20 ms, and specifically less than 15 ms, 10 ms, 5 ms, 1 ms, 500 μs or 100 μs. A quasi-instantaneous switch-off is achieved accordingly.

By means of the optionally provided current sensor unit SI, which is connected to the control unit SE, for ascertaining the magnitude of a current in the conductors of the low-voltage circuit, the circuit-breaker SG can be configured such that, in the event of an overshoot of first current limiting values (i.e. if the magnitude of the current exceeds the (amount of the) first current limiting value) or of first current-time limiting values (i.e. the first current limiting value is exceeded for a first time period; i.e. if the magnitude of the (amount of the) current exceeds the first current limiting value for a first time period), a prevention of a current flux in the low-voltage circuit is initiated by a high-ohmic state of the switching elements of the electronic interruption unit, with the break contacts in a closed state.

The mechanical break contact unit MK, in the present example, is arranged on the load side, and the electronic interruption unit EU, according to the invention, is arranged on the grid side.

Under normal circumstances, an electric voltage is applied to the grid side GRID, having the energy source. On the load side LOAD, an electrical load is customarily connected.

This provides an advantage, in that no further (in particular, live) parts or components are located between the contacts of the mechanical break contact unit/load-side connection points (APLL, APNL) of the mechanical break contact unit and the two load-side terminals (LL, NL). By means of this architecture or design, it can thus be ensured that, where the contacts KKL, KKN are open, under no circumstances is a voltage present on the load-side terminals LL, NL. The safety of the circuit-breaker is enhanced accordingly.

Conversely, in other architectures, in which the mechanical break contact unit is arranged on the grid side, in many cases, electronic units (which are not galvanically isolated) are located up-circuit of the load-side terminal.

The circuit-breaker can be configured such that the magnitude of the voltage across the electronic interruption unit can be ascertained. This means that the magnitude of a first voltage between the grid-side connection point EUG and the load-side connection point EUL of the electronic interruption unit EU can be ascertained, or is ascertained.

To this end, in the example according to FIG. 1, a first voltage sensor unit SU1 is provided, which is connected to the control unit SE, and which ascertains the magnitude of the voltage between the grid-side connection point EUG and the load-side connection point EUL of the electronic interruption unit EU.

For the voltage measurement by the first voltage sensor unit SU1, alternatively, the voltage across the series-connected arrangement of the electronic interruption unit EU and the current sensor SI can also be ascertained, as represented in FIG. 1. The current sensor unit SI has a very low internal resistance, such that ascertainment of the magnitude of voltage is not impaired, or is only impaired to a negligible extent.

The circuit-breaker can be configured such that a second voltage sensor unit SU2 is provided, which ascertains the magnitude of the voltage between the grid-side neutral conductor terminal NG and the grid-side phase conductor terminal LG.

The first voltage sensor unit can also be replaced, wherein two voltage measurements (up-circuit of the electronic interruption unit and down-circuit of the electronic interruption unit) are employed. The voltage across the electronic interruption unit is ascertained by a differential formation.

A/the second voltage sensor unit SU2, which is connected to the control unit SE, can thus be provided, which ascertains the magnitude of a second voltage between the grid-side neutral conductor terminal NG and the grid-side phase conductor terminal LG. Moreover, an (unrepresented) third voltage sensor unit SU3 can be provided, which is connected to the control unit, and which ascertains the magnitude of a third voltage between the grid-side neutral conductor terminal NG and the load-side connection point EUL of the electronic interruption unit EU. The circuit-breaker is configured such that, from the difference between the second and the third voltage, the magnitude of a/the first voltage between the grid-side connection point EUG and the load-side connection point EUL of the electronic interruption unit EU is ascertained.

Between the grid-side connection points APLG, APNG of the mechanical break contact unit MK, a measuring impedance ZM can be connected. The measuring impedance ZM can be, for example, an electrical resistor and/or a capacitor. The measuring impedance can moreover be an inductance. In particular, the measuring impedance can comprise a series-connected arrangement or a parallel-connected arrangement of a resistor and/or a capacitor and/or an inductance.

In the example according to FIG. 1, the electronic interruption unit EU is embodied as a single-pole unit, in the present example, in the phase conductor. The grid-side connection point APNG for the neutral conductor of the mechanical break contact unit MK is connected to the grid-side neutral conductor terminal NG of the housing GEH.

The circuit-breaker SG is advantageously configured such that the contacts of the mechanical break contact unit MK are opened by means of the control unit SE, but cannot be closed, as indicated by an arrow between the control unit SE and the mechanical break contact unit MK.

The mechanical break contact unit MK is operable by means of a mechanical handle HH on the circuit-breaker SG, in order to execute a manual (hand-operated) opening or closing of the contacts KKL, KKN. The mechanical handle HH indicates the circuit state (open or closed) of the contacts of the mechanical break contact unit MK, in particular by means of an (exclusively) mechanical connection, on the circuit-breaker. Moreover, the contact position (or the position of the handle, whether closed or open) can be communicable to the control unit SE. The contact position (or the position of the handle) can be ascertained e.g. by means of a sensor, such as a position sensor. The contact position or the circuit state can be communicated to the control unit SE. The position sensor can be an element of the mechanical break contact unit MK. Alternatively, the position sensor can be a component in an electronic first part (EPART, FIG. 2). For example, in the electronic first part (EPART), a Hall effect sensor can be provided, which executes the contactless capture and communication of the position of the contacts and/or of the handle.

The mechanical break contact unit MK is advantageously configured such that a (manual) closing of the contacts by means of the mechanical handle is only possible further to a release (enable command), in particular further to an enable signal. This is also indicated by the arrow between the control unit SE and the mechanical break contact unit MK. This means that the contacts KKL, KKN of the mechanical break contact unit MK can only be closed by means of the handle HH in the event that an enable command or enable signal (delivered by the control unit) is in force. In the absence of this enable command or enable signal, the handle HH can be actuated, but the contacts will not be closed (“continuous slider” action).

The circuit-breaker SG comprises an energy supply or power supply unit NT, for example a switched-mode power supply unit. In particular, the energy supply/power supply unit NT is provided for the control unit SE, which is indicated by a connection between the energy supply/power supply unit NT and the control unit SE in FIG. 1. The energy supply/power supply unit NT (on the other side) is connected to the grid-side neutral conductor terminal NG and to the grid-side phase conductor terminal LG. In the connection to the grid-side neutral conductor terminal NG (and/or to the phase conductor terminal LG), advantageously, a fuse SS, in particular a fusible link, or a switch Sch (FIG. 2) can be provided.

According to the invention, under normal circumstances, the power supply unit NT is permanently supplied with energy, specifically from the grid-side terminals. Optionally, it is protected by the fuse SS, or can be disconnected by means of the switch Sch.

Advantageously, the switch Sch can be embodied such that the switch can only be opened if the contacts are in the open state. This enhances the security of the device, as the electronics (in particular the control unit) cannot be switched off when the contacts are closed.

The intended function of the fuse SS is not only the protection of the energy supply from the power supply unit NT, but also, particularly in the case of a two-part circuit layout (see FIG. 2), the protection of the “electronic” first part EPART or, in particular, of all the constituent units thereof (including, specifically, the control unit, the electronic interruption unit, optionally the voltage sensor unit(s), the differential current sensor unit, optionally the current sensor unit, optionally the measuring impedance, etc.).

Alternatively, the measuring impedance ZM, via the fuse SS, can be connected to the grid-side neutral conductor terminal NG. Advantageously, a three-pole electronics unit or an electronic first part EPART (FIG. 2) can thus be embodied, for example in the form of a module, which comprises three terminals in relation to the low-voltage circuit-one neutral conductor terminal and two phase conductor terminals. The electronic first part EPART can comprise further terminals, in particular for control or measurement information, such as terminals for an enable signal “Enable”/enable command, an opening signal OEF, positional information (delivered by the position unit POS) and/or a differential current signal (magnitude of the differential current) delivered by the differential current sensor unit ZCT.

The electronics unit or the electronic first part EPART (FIG. 2) comprises, for example, the electronic interruption unit EU, the control unit SE, the power supply unit NT (in particular, including the fuse SS), the current sensor unit SI, optionally the first voltage sensor unit SU1 and/or optionally the second voltage sensor unit SU2.

With respect to the three terminals relating to the low-voltage circuit of the electronic first part EPART, an advantage is thus provided, in that only two phase conductor terminals are required to assume a high current-carrying capacity (a number of amperes, in order to conduct the load current), whereas the neutral conductor terminal is only required to assume a (comparatively) low current-carrying capacity (for example lower than 1 A, or a few mA-depending upon the energy demand of the control unit). This simplifies construction, and enhances the security of the device on the grounds that, in the event of a fault on the electronic first part EPART, no high short-circuit current can flow via this connection.

The low-voltage circuit can be a three-phase AC circuit, having a neutral conductor and three phase conductors. To this end, the circuit-breaker can be configured as a three-phase variant and, for example, can comprise further grid-side and load-side phase conductor terminals. Between the further grid-side and load-side phase conductor terminals, in an analogous manner, electronic interruption units and contacts of the mechanical break contact unit according to the invention are provided in each case. The respective conductors (three phase conductors L1, L2, L3, and the neutral conductor N) are led through the differential current unit ZCT.

Current sensor units and voltage ascertainment functions (e.g. by means of first voltage sensor units) can also be provided.

The term “high-ohmic” signifies a state in which only a current of negligible magnitude continues to flow. In particular, the term “high-ohmic” signifies resistance values greater than 1 kiloohm, preferably greater than 10 kiloohms, 100 kiloohms, 1 megaohm, 10 megaohms, 100 megaohms, 1 gigaohm, or greater.

The term “low-ohmic” signifies a state in which the current value which is indicated on the circuit-breaker can flow. In particular, the term “low-ohmic” signifies resistance values which are lower than 10 ohms, preferably lower than 1 ohm, 100 milliohms, 10 milliohms, 1 milliohm, or lower.

FIG. 2 shows a representation according to FIG. 1, with the distinction that the circuit-breaker is of a two-part design. The circuit-breaker contains an electronic first part EPART, for example arranged on a PCB/printed circuit board.

The first part EPART can comprise the control unit SE, the first voltage sensor unit SU1, the second voltage sensor unit SU2, the current sensor unit SI, the electronic interruption unit EU, and the power supply unit NT. The first part can further comprise the fusible links SS, a switch Sch, the measuring impedance ZM, a temperature sensor TEM (in particular for the electronic interruption unit EU), a communication unit COM, a display unit AE and, by way of a variant, a position sensor unit POS.

The electronic first part EPART comprises only three terminals for connecting to the low-voltage circuit:
the grid-side phase conductor terminal LG, by way of a first terminal;
a (second) terminal for the, or to the, grid-side phase conductor connection point APLG of the mechanical break contact unit MK;
a third terminal EN, for connecting to the grid-side neutral conductor terminal NG.

The two terminals: terminal LG to the grid-side phase conductor, and the terminal for the, or to the, grid-side phase conductor connection point APLG, assume a high current-carrying capacity, e.g. of a number of amperes, and greater than 10 A/16 A—depending upon the nominal current or rated current of the low-voltage circuit, in particular in order to carry the load current even in the event of a short-circuit or an overload.

The third terminal EN for connecting to the grid-side neutral conductor terminal NG assumes a (comparatively) low current-carrying capacity, e.g. lower than 1 A, or a few mA—depending upon the energy demand of the units supplied, specifically in the electronic first part EPART. The third terminal EN is embodied with a low current-carrying capacity, in order to supply the power supply unit with power, and to enable a voltage measurement between the phase conductor and the neutral conductor of the low-voltage circuit. In particular, this third terminal EN is protected by a fuse SS. This can be embodied in the form of a fusible link, or in the form of a cost-effective printed conductor fuse (a thin printed conductor having a corresponding length and thickness on the printed circuit board). This provides a particular advantage in that, as a result of the low current-carrying capacity of this conductor or on this third terminal EN, protection against a short-circuit which occurs within the electronic first part (EPART) (or on the (electronic) units), e.g. on the side of the power supply unit or of the control unit, is improved.

This means that, in the event of a loss or failure of an electronic component of a unit within the electronic first part EPART, no hazardous short-circuit current can occur (fed by the grid-side terminals LG, NG), which might result in a fire in the device.

This short-circuit current is fed by the grid, via the grid-side terminals. In many cases, an up-circuit circuit-breaker assumes a far higher trip current, and supplies low-voltage circuits which are arranged in parallel. Accordingly, in the event of a fault in the circuit-breaker (the circuit-breaker of the protected low-voltage circuit) and the tripping of the up-circuit circuit-breaker, other non-defective parallel circuits would also be tripped, which tripping can thus be prevented.

In particular, the communication unit COM can be a wireless communication unit. The communication unit COM can comprise a (manual) input unit on the circuit-breaker, for the (manual) acknowledgement of states on the circuit-breaker SG.

Acknowledgement can also be executed (in a hard-wired and/or wireless arrangement) by means of the communication unit COM.

The communication unit COM can further comprise a display function. A separate display unit can also be provided.

The circuit-breaker incorporates an, in particular mechanical, second part MPART. The second part MPART can comprise the mechanical break contact unit MK, the handle HH, and an enable unit FG. The second part can further comprise a position unit POS, for notifying the position of the contacts of the mechanical break contact unit MK to the control unit, and the (neutral conductor) connection(s). The second part MPART comprises the differential current sensor unit ZCT, such as a summation current transformer, of the type which is known, for example, from conventional fault current circuit breakers.

Further units, which are not illustrated in greater detail, can be provided.

By means of the two-part structure, advantageously, a compact circuit-breaker according to the invention can be embodied, having a simplified construction.

The enable unit/enable function FG enables the actuation of the contacts of the mechanical break contact unit by means of the handle HH, in the event that an enable signal “enable” is present. This means that a closing of the contacts KKL, KKN by means of the handle will only be possible in the event of the presence of the enable signal “enable” (delivered by the control unit SE). Otherwise, closing is not possible (continuous slider action of the handle HH). The contacts will remain in the open position/circuit state. Moreover, the enable unit FG can execute an opening of the contacts (second function of the enable unit FG), in the event that an opening signal OEF (delivered by the control unit SE) is present. In this case, the enable unit/enable function FG functions as a trip unit for opening the contacts of the mechanical break contact unit MK.

The circuit-breaker SG, in particular the control unit SE, is further configured such that, in the event of an overshoot of current limiting values or of current-time limiting values (i.e. where a current limiting value is exceeded for a specific time interval) a prevention of a current flux in the low-voltage circuit is initiated, in particular in order to prevent a short-circuit. In particular, this is achieved by means of the switchover of the electronic interruption unit EU from the low-ohmic state to the high-ohmic state. Initiation of the prevention of a current flux in the low-voltage circuit is executed, for example, by a first interruption signal, which is transmitted by the control unit SE to the electronic interruption unit EU.

Alternatively or additionally, the mechanical break contact unit MK can be actuated by the control unit SE, in order to initiate a prevention of a current flux in the low-voltage circuit in the event of an overshoot of current limiting values or of current-time limiting values. Specifically, a galvanic isolation is optionally effected. Initiation of the prevention of a current flux or, optionally, of a galvanic interruption of the low-voltage circuit is executed, for example, by a second interruption signal, which is transmitted by the control unit SE to the mechanical break contact system MK.

The electronic interruption unit EU can comprise semiconductor components, such as bipolar transistors, field-effect transistors (FETs), isolated gate bipolar transistors 9 (IGBTs), metal-oxide semiconductor field-effect transistors (MOSFETs) or other (self-commutated) power semiconductors. In particular, on the grounds of their low forward resistances, high junction resistances and effective switching behavior, IGBTs and MOSFETs are particularly appropriate for the circuit-breaker according to the invention.

In particular, by means of the mechanical break contact unit MK, a (regulation) isolating function is signified, which is embodied by the break contact unit MK. The term “isolating function” signifies the following points:
a regulation (voltage-dependent) minimum contact gap (minimum clearance of contacts);
a contact position indication of the contacts of the mechanical break contact system;
a facility for the opening of the mechanical break contact system at all times (no immobilization of the break contact system-in particular by means of the handle, trip-free mechanism).

Within the meaning of the invention, for the isolating function and the properties thereof, the standard series DIN EN 60947 or IEC 60947 are applicable, the consideration of which is included herein by reference.

The circuit-breaker can be configured as a top hat rail-mounted circuit-breaker SG having a width of e.g. 1 HP, 1.5 HP or 2 HP, with two-pole terminals (L, N). In electrical installations and switch cabinet construction, the width of built-in devices, such as circuit-breakers, line circuit-breakers, fault current circuit-breakers, etc., is expressed in units of horizontal pitch, or HP for short. The width of a unit of horizontal pitch is ˜18 mm. According to DIN standard 43880:1988-12, the built-in width of devices is intended to lie between 17.5 and 18.0 mm, or is calculated herefrom by the multiplication of this dimension by 0.5, or by a whole-number multiple, i.e.: k×0.5×18 mm or k×0.5×17.5 mm (where k=1, 2, 3, . . . ). Thus, for example, a single-pole line circuit-breaker according to the prior art has a width of 1 HP. According to DIN 43871 “Consumer units for built-in equipment up to 63 A”, built-in units of electrical installation distribution boards are matched to units of horizontal pitch, e.g. the width of mounting rails/top hat rails.

According to the invention, the circuit-breaker SG, in particular the control unit SE, is configured such that, in the event of an overshoot of r.m.s. differential current-time limiting values, a prevention of a current flux in the low-voltage circuit is initiated, e.g. by means of a high-ohmic state of switching elements of the electronic interruption unit, with the break contacts in a closed state. The r.m.s. differential current-time limiting values can be limiting values according to applicable standards, such as DIN EN 61008-1. These are, for example, 30 mA and a time of 300 ms, 150 ms, 40 ms or 20 ms for the protection of persons in Europe in a 230 V low-voltage circuit, 6 mA and the same time for the protection of persons in North America, and 300 mA and the same time for fire protection (230 V r.m.s. value).

The instantaneous differential current limiting value DSGm can be quantitatively higher than the r.m.s. differential current-time limiting value. In particular, the instantaneous differential current limiting value DSGm is a value within the range of 2- to 100-times the first differential current-time limiting value.

The instantaneous differential current limiting value DSGm can assume, for example, a value of 200 mA. This means that, for example, upon the achievement of a differential current value of 200 mA, a (quasi-) instantaneous prevention of the current flux is executed, in particular within 20 ms, and specifically within 15 ms, 10 ms, 5 ms, 1 ms, 500 μs or 100 μs.

Further to the prevention of the current flux in the low-voltage circuit, which is initiated by the overshoot of the instantaneous differential current limiting value, according to one configuration, a low-ohmic state is assumed by the switching elements of the electronic interruption unit. The low-ohmic state is assumed, in particular, at a magnitude of the instantaneous AC voltage value which is lower than a first voltage limit. To this end, advantageously, the second voltage sensor unit SU2 can be provided. The first voltage limit can be, for example, lower than 10 volts or lower than 5 volts. Specifically, the assumption of a low-ohmic state by the switching elements of the electronic interruption unit is executed in a zero-crossing of the AC voltage.

Further to the assumption of the low-ohmic state, a further overshoot of the instantaneous differential current limiting value is detected. Thereafter, a high-ohmic state can again be assumed, followed by a low-ohmic state, until a first number (x) of overshoots has been achieved. The first number of overshoots can be, for example, a value within the range of 2 to 20 overshoots. If this first number (x) of overshoots is exceeded, for example an opening of the contacts of the mechanical break contact unit MK (for galvanic isolation) is executed. Alternatively, the electronic interruption unit can also remain in the high-ohmic state.

The respective states can be notified by the communication unit, or displayed by means of the display unit AE.

FIG. 3 shows an exemplary representation of the abovementioned behavior of a differential current if which is caused, for example, by a ground fault current. In FIG. 3, the upper diagram shows the magnitude or temporal characteristic of the differential current if, plotted against time t, with the associated prevention of a current flux OFF, by means of an open state of the break contacts (galvanic isolation), or enablement of the current flux ON (=a current-carrying capability of the circuit-breaker), for a fault current circuit-breaker according to the prior art.

In the central diagram, the magnitude or temporal characteristic of the alternating voltage ug in the (for example 50 Hz-) low-voltage circuit at the grid-side terminals of the circuit-breaker is plotted against time t (in milliseconds ms).

In the lower diagram, the magnitude or temporal characteristic of the differential current if is plotted against time t, wherein associated events are represented by the following symbols:
OFF=prevention of a current flux by means of an open state of the break contacts (galvanic isolation);
STB=prevention of a current flux by means of a high-ohmic state of the electronic interruption unit EU;
ON=current flux (=a current-carrying capability of the circuit-breaker), for a circuit-breaker according to the invention.

In the upper diagram, representing the behavior of a fault current circuit-breaker according to the prior art, an event which generates a differential current, for example a ground fault current, occurs at a time point t of approximately 5 ms. In the example represented, the magnitude of the differential current is approximately 400 mA. Thereafter, in a conventional fault current circuit-breaker, the prevention of a current flux OFF (switch-off) is executed after approximately 17 ms (at a time point of approximately 22 ms). This means that, from the occurrence of the event up to the prevention of the current flux, a current flux ON is enabled in the low-voltage circuit, and the prevention of the current flux OFF is only executed thereafter, by means of open contacts.

In the lower diagram, representing the behavior of a circuit-breaker according to the invention, an event which generates a differential current, for example a ground fault current, occurs at a time point t of approximately 5 ms. In the example represented, the magnitude of the differential current would also theoretically achieve a value of approximately 400 mA. According to the invention, a (quasi-) instantaneous prevention of a current flux OFF is executed in response to the achievement of the instantaneous differential current limiting value, for example 200 mA, within the switch-off time, such that the potential differential current, e.g. of 400 mA, is not achieved (current limitation). Prevention of the current flux is executed by means of a high-ohmic state STB of the switching elements of the electronic interruption unit. This is executed, for example, in response to an instantaneous evaluation of the magnitude of the differential current by means of the control unit SE.

Thereafter, for example, a low-ohmic state is assumed by the switching elements of the electronic interruption unit EU, in the event that a magnitude of the instantaneous AC voltage value is lower than a first voltage limit. In the example according to FIG. 3, assumption of a low-ohmic state by the switching elements of the electronic interruption unit is executed in a zero-crossing of the AC voltage, specifically in the next (or next but one) zero-crossing of the AC voltage (for example depending upon the time of the occurrence of the event which gives rise to the differential current). In the event that, thereafter (optionally), the differential current if achieves the r.m.s. differential current-time limiting value, a prevention of the current flux in the low-voltage circuit is executed, as indicated.

For example, the prevention of the current flux is executed in the next zero-crossing of the AC voltage, as indicated. The prevention of the current flux can be executed by means of a high-ohmic state of the switching elements of the electronic interruption unit, with the break contacts in a closed state (STB state). Alternatively (and conventionally), prevention of the current flux can be executed by an open state OFF of the break contacts.

This means that, in the circuit-breaker according to the invention, further to an overshoot of the instantaneous differential current limiting value and a quasi-instantaneous prevention of the current flux in the low-voltage circuit, the assumption of a further (experimental) low-ohmic state is executed, in order to test for the presence of the event giving rise to the differential current.

FIG. 4 shows a representation according to FIG. 3, with the distinction that, exemplarily, the above-mentioned behavior is represented for a differential current if which is generated, for example, by an operational differential current pulse.

In the upper diagram, representing the behavior of a fault current circuit-breaker according to the prior art, at a time point t of approximately 5 ms, an event which generates a differential current occurs, for example an operational differential current pulse or a technically related differential current pulse of the type which can occur, for example, in conjunction with switching operations, in particular closing operations, and in frequency converters in a low-voltage AC circuit. Differential current pulses of this type are generally non-critical with respect to the protection of persons, as they originate from non-ideal technical switching operations, rather than from persons. Previously, some action has been undertaken for the resistant design of conventional fault current circuit-breakers against operational differential current pulses or technically related differential current pulses, in the interests of preventing (technically related) spurious tripping, or of improving security of supply in a low-voltage circuit.

In the example represented, the magnitude of the differential current (again) is greater than approximately 400 mA. Thereafter, in a conventional fault current circuit-breaker according to the prior art, the prevention of a current flux/OFF state (open contacts, switch-off) is executed after approximately 17 ms (at a time point of approximately ms (on the falling edge of the differential current pulse). This means that, from the occurrence of the event up to the prevention of the current flux, a current flux ON is enabled in the low-voltage circuit, and the prevention of the current flux OFF is only executed thereafter, by means of open contacts.

In the lower diagram, representing the behavior of a circuit-breaker according to the invention, an event which generates a differential current, in the example represented an operational differential current pulse or a technically related differential current pulse, occurs at a time point t of approximately 5 ms.

In the example represented, the magnitude of the differential current would also theoretically achieve a value of approximately 400 mA or more. According to the invention, a (quasi-) instantaneous prevention of a current flux (within the (first) switch-off time)—STB state (high-ohmic interruption unit)—is executed in response to the achievement of the instantaneous differential current limiting value, for example 200 mA, such that the potential differential current e.g. of (greater than) 400 mA, is not achieved (current limitation). Prevention of the current flux is executed by means of a high-ohmic state of the switching elements of the electronic interruption unit—STB state. This is executed, for example, in response to an instantaneous evaluation of the magnitude of the differential current by means of the control unit SE.

Thereafter, for example, a low-ohmic state is assumed by the switching elements of the electronic interruption unit EU, in the event that a magnitude of the instantaneous AC voltage value is lower than a first voltage limit. In the example according to FIG. 4, assumption of a low-ohmic state by the switching elements of the electronic interruption unit is executed in a zero-crossing of the AC voltage, specifically in the next (or next but one) zero-crossing of the AC voltage (for example, depending upon the time of the occurrence of the event which gives rise to the differential current).

In the event that, thereafter (optionally), the differential current if achieves the instantaneous differential current-time limiting value, a prevention of the current flux in the low-voltage circuit would be executed. In the event that the instantaneous differential current limiting value, or (optionally), the r.m.s. differential current-time limiting value, is not achieved, as indicated, the electronic interruption unit remains in a low-ohmic state for the enablement of a current flux ON, as illustrated.

FIG. 5 shows a representation of a functional sequence, having various function blocks and state blocks. A differential current sensor unit ZCT/10 ascertains the magnitude of a differential current in the conductors of the low-voltage circuit, and captures or supplies instantaneous differential current values which, for example, are relayed to a control unit SE.

Instantaneous differential current values from the differential current sensor unit ZCT/10 firstly undergo a first evaluation 100 which, for example, ascertains a r.m.s. (root mean square) value of the differential current I_{Diff,rms}, block RMS/101, and executes a check for an overshoot of the first differential current-time limiting values DSG1, with respect to “I_{Diff,rms}>DSG1”/102. In the event of an overshoot of the first differential current-time limiting values DSG1, a prevention of a current flux in the low-voltage circuit is prevented:
a) by a high-ohmic state of the switching elements of the electronic interruption unit, with the break contacts in a closed state, “standby” block STB2/401;
b) by an open state of the break contacts OFF/400=>block OFF.

Whether a) or b) is executed, according to the or/110 function, can be determined by a device configuration conf/111, or defined as a setpoint.

Instantaneous differential current values secondly undergo a second evaluation “|i_{Diff,rms}(t)|>DSG2” 200 which, in the example represented, employs the magnitude of the instantaneous differential current value with respect an overshoot of the second differential current limiting value DSG2. In the event of an overshoot of the second differential current limiting value DSG2, a prevention of a current flux in the low-voltage circuit is initiated by a high-ohmic state of the switching elements of the electronic interruption unit, with the break contacts in a closed state STB=>block STB/201.

Prevention of the current flux in the low-voltage circuit by means of a high-ohmic state of the switching elements of the electronic interruption unit STB is executed within a first switch-off time which, in particular, is less than 20 ms, and specifically less than 15 ms, 10 ms, 5 ms, 1 ms, 500 μs or 100 μs.

Further to the prevention of the current flux STB/201, a low-ohmic state is assumed by the switching elements of the electronic interruption unit ON/402, which low-ohmic state is assumed, in particular, at a magnitude of the instantaneous AC voltage value which is lower than a first voltage limit, for example lower than 10 volts, “(at |u(t)|<10 V)”/402.

In the event that, further to the assumption of a low-ohmic state, a further overshoot of the second differential current value DSG2 occurs, this overshoot is captured by a counter 300. If a first number x of overshoots is exceeded, in particular, an opening of the contacts of the mechanical break contact unit MK is executed for the prevention of a current flux OFF=>block OFF/400. Alternatively, a continuous, or intermittently continuous high-ohmic state of the switching elements of the electronic interruption unit, with the break contacts in a closed state STB2/401, can also be assumed=>block STB2/401.

If the first number has yet to be achieved, a low-ohmic state is assumed by the switching elements of the electronic interruption unit, for enabling a current flux ON=>block ON/block 402.

The circuit-breaker SG, in particular the control unit SE, can comprise a microcontroller (=microprocessor) on which a computer program product runs, which computer program product comprises commands which, upon the execution of the program by the microcontroller, initiate the execution by the latter of a check (as described heretofore and hereinafter) of a circuit-breaker.

The computer program product can advantageously be saved on a computer-readable storage medium, such as a USB stick, a CD-ROM, etc., in order to enable e.g. an upgrade to an extended version.

Alternatively, the computer program product can also be advantageously transmitted by means of a data carrier signal.

The control unit SE can be embodied:
in the form of a digital circuit, e.g. in the form of a (further) microprocessor; the (further) microprocessor can also contain an analog component;
in the form of a digital circuit, having analog circuit components.

Although the invention has been illustrated and described in greater detail with reference to the exemplary embodiment, the invention is not limited by the examples disclosed, and further variations can be inferred herefrom by a person skilled in the art, without departing from the protective scope of the invention.

1-18. (canceled)

19. A circuit-breaker for protecting a low-voltage electric circuit for an AC voltage, the circuit-breaker comprising:
a housing having grid-side and load-side terminals for conductors of the low-voltage circuit;
a differential current sensor unit for ascertaining a magnitude of an instantaneous differential current in the conductors of the low-voltage circuit;
a mechanical break contact unit having contacts, said mechanical break contact unit assuming a closed state of said contacts for enabling a current flux in the low-voltage circuit, or an open state of said contacts for preventing a current flux by a galvanic interruption of the low-voltage circuit;
an electronic interruption unit having a circuit side connected in series with said mechanical break contact unit, said electronic interruption unit having semiconductor-based switching elements assuming a high-ohmic state of said switching elements for preventing a current flux, or a low-ohmic state of said switching elements for enabling the current flux in the low-voltage circuit; and
a control unit connected to said differential current sensor unit, to said mechanical break contact unit and to said electronic interruption unit;
said control unit configured to compare a magnitude of the instantaneous differential current with an instantaneous differential current limiting value and, in an event of a quantitative overshoot, to prevent the current flux in the low-voltage circuit initiated by a high-ohmic state of said switching elements of said electronic interruption unit with said break contacts in said closed state.

20. The circuit-breaker according to claim 19, wherein a current flux in the low-voltage circuit is prevented in the event of the overshoot by a high-ohmic state of said switching elements of said electronic interruption unit within a first switch-off time.

21. The circuit-breaker according to claim 20, wherein said first switch-off time is less than 20 ms.

22. The circuit-breaker according to claim 19, wherein:
a low-ohmic state of said switching elements of said electronic interruption unit is initiated, further to the prevention of the current flux in the low-voltage circuit in response to the overshoot of the instantaneous differential current limiting value; and
a voltage sensor unit is connected to said control unit for ascertaining a magnitude of a voltage in the conductors of the low-voltage circuit, and a low-ohmic state is assumed in which a magnitude of an instantaneous value of the AC voltage is lower than a first voltage limit.

23. The circuit-breaker according to claim 22, wherein:
said first voltage limit is lower than 20 volts; and
a low-ohmic state of said switching elements of said electronic interruption unit is assumed in a zero-crossing of the AC voltage.

24. The circuit-breaker according to claim 22, wherein:
further to the assumption of the low-ohmic state, a further overshoot of the instantaneous differential current limiting value is detected, a high-ohmic state is assumed, followed by a low-ohmic state, until a first number of overshoots has been achieved; and
said contacts of said mechanical break contact unit are opened.

25. The circuit-breaker according to claim 19, wherein:
a r.m.s. value of the differential current is ascertained from the magnitude of the instantaneous differential current;
the r.m.s. value of the differential current is compared with a r.m.s. differential current limiting value or with a r.m.s. differential current-time limiting value and, in an event of an overshoot, prevention of the current flux in the low-voltage circuit is initiated:
a) by a high-ohmic state of said switching elements of said electronic interruption unit, with said break contacts in said closed state, or
b) by an open state of said break contacts.

26. The circuit-breaker according to claim 25, wherein the instantaneous differential current limiting value is quantitatively higher than the r.m.s. differential current limiting value or the r.m.s. differential current-time limiting value.

27. The circuit-breaker according to claim 26, wherein the instantaneous differential current limiting value is a value within a range of 2 to 100 times the r.m.s. differential current limiting value or the r.m.s. differential current-time limiting value.

28. The circuit-breaker according to claim 19, which further comprises:
a current sensor unit connected to said control unit for ascertaining a magnitude of a current in the conductors of the low-voltage circuit;
the circuit-breaker or said control unit configured to initiate, in an event of an overshoot of first current limiting values or of first current-time limiting values, a prevention of the current flux in the low-voltage circuit by a high-ohmic state of said switching elements of said electronic interruption unit, with said break contacts in said closed state.

29. The circuit-breaker according to claim 19, wherein said mechanical break contact unit is associated with said load side terminals.

30. A method for using a circuit-breaker for protecting a low-voltage electric circuit for an AC voltage, the method comprising:
ascertaining a magnitude of an instantaneous differential current in conductors of the low-voltage circuit; and
in an event of an overshoot of an instantaneous differential current limiting value, initiating a prevention of a current flux in the low-voltage circuit by a high-ohmic state of switching elements of an electronic interruption unit, with break contacts of a mechanical break contact unit in a closed state.

31. The method according to claim 30, which further comprises in the event of the overshoot of the instantaneous differential current limiting value, executing the prevention of the current flux in the low-voltage circuit by the high-ohmic state of the switching elements of the electronic interruption unit within a first switch-off time.

32. The method according to claim 31, which further comprises setting the first switch-off time at less than 20 ms.

33. The method according to claim 30, which further comprises:
assuming a low-ohmic state by the switching elements of the electronic interruption unit, further to the prevention of the current flux in the low-voltage circuit in response to the overshoot of the instantaneous differential current limiting value; and
assuming a low-ohmic state in which a magnitude of the instantaneous value of the AC voltage is lower than a first voltage limit.

34. The method according to claim 30, which further comprises:
further to the assumption of the low-ohmic state, a further overshoot of the instantaneous differential current limiting value is detected, a high-ohmic state is assumed, followed by a low-ohmic state, until a first number of overshoots has been achieved; and
then opening the contacts of the mechanical break contact unit.

35. The method according to claim 30, which further comprises:
ascertaining a r.m.s. value of the differential current from the magnitude of the instantaneous differential current;
comparing the r.m.s. value of the differential current with a r.m.s. differential current limiting value or with a r.m.s. differential current-time limiting value and, in an event of an overshoot, initiating a prevention of a current flux in the low-voltage circuit:
a) by a high-ohmic state of the switching elements of the electronic interruption unit, with the break contacts in a closed state, or
b) by an open state of the break contacts.

36. The method according to claim 30, which further comprises ascertaining a magnitude of a current in the conductors of the low-voltage circuit and, in an event of an overshoot of first current limiting values or of first current-time limiting values, initiating a prevention of a current flux in the low-voltage circuit by a high-ohmic state of the switching elements of the electronic interruption unit, with the break contacts in a closed state.

37. A non-transitory computer program product with commands which, upon execution of the program by a microcontroller, initiate a support or execution by the microcontroller of the method according to claim 30.

38. A non-transitory computer-readable storage medium, on which the non-transitory computer program product according to claim 37 is saved.

39. A data carrier signal, being transmitted by the non-transitory computer program product according to claim 37.
